(19) United States
(12) Patent Application Publication
(10) Pub. No.: US 2015/0096003 A1
(43) Pub. Date: Apr. 2, 2015

(54) PORTABILITY TYPE SEMICONDUCTOR MEMORY DEVICE AND THE OPERATING METHOD

(71) Applicant: Kabushiki Kaisha Toshiba, Minato-ku (JP)

(72) Inventor: Hiroko OKABAYASHI, Tokyo (JP)

(73) Assignee: Kabushiki Kaisha Toshiba, Minato-ku (JP)

(21) Appl. No.: 14/193,551

(22) Filed: Feb. 28, 2014

(30) Foreign Application Priority Data
Sep. 27, 2013 (JP) 2013-202535

(51) Int. Cl. H04L 29/06; H04L 29/08

(52) U.S. Cl. CPC H04L 63/08; H04L 67/1097
USPC 726/7; 709/213

(57) ABSTRACT

According to one embodiment, a portability type semiconductor memory device includes communications circuitry, an interface circuitry, a non-transitory computer readable memory, a first retrieval circuitry, a second retrieval circuitry. If the at least one access point is not within communicating range, the portability-type semiconductor memory device is configured to disregard commands from the host device. If the at least one access point is within communicating range, as determined by the first retrieval circuitry, the second retrieval circuitry is further configured to determine whether the server is accessible through the access point, based on the stored information.

### CROSS-REFERENCE TO RELATED APPLICATIONS

This application is based upon and claims the benefit of priority from prior Japanese Patent Application No. 2013-202535, filed Sep. 27, 2013; the entire contents of both of which are incorporated herein by reference.

### FIELD

Embodiments described herein relate generally to a portability-type semiconductor memory device with a wireless LAN function.

### BACKGROUND

In recent years, in the company the outflow of customer data are social concerns. Each company has indispensable strengthening of the information security. In the way of an indicator of whether to implement security countermeasures as the company, it is popularity to acquire ISMS (Information Security Management System) qualification.

If the company did not acquire ISMS, it will be difficult to receive the order of work. Therefore, when the company undertakes an enterprise, it is an important measure to perform exactly the security countermeasures to the information held for it.

### BRIEF DESCRIPTION OF THE DRAWINGS

FIG. 1 is the block diagram of the memory system concerning a first embodiment.

FIG. 2 is the flow chart which shows the operation at the time of an initial-data setup concerning a first embodiment.

FIG. 3 is the flow chart which shows card initialization concerning a first embodiment, and operation of the server authentication 1.

FIG. 4 is the flow chart which shows card initialization concerning a first embodiment, and operation of the server authentication 2.

FIG. 5 is the flow chart which shows the data reading operation concerning a first embodiment.

FIG. 6 is the flow chart which shows the data writing operation concerning a first embodiment.

FIG. 7 is the block diagram of the memory system concerning a second embodiment.

FIG. 8 is the flow chart which shows card initialization concerning a second embodiment.

### DETAILED DESCRIPTION

In general, according to one embodiment, in a portability-type semiconductor memory device comprising communications circuitry configured to transmit data to, and receive data from, a server via a network, interface circuitry configured to transmit data to, and receive data from, a host device, a non-transitory computer readable memory configured to store information of at least one access point and the server received from the host device via the interface circuitry, first retrieval circuitry configured to search for the least one access point within communicating range of the communications circuitry, based on the stored information, and second retrieval circuitry configured to search for the server through the access point, based on the stored information. If the at least one access point is not within communicating range, the portability-type semiconductor memory device is configured to disregard commands from the host device. If the at least one access point is within communicating range, as determined by the first retrieval circuitry, the second retrieval circuitry is further configured to determine whether the server is accessible through the access point, based on the stored information.

For example, in the company using various portability-type semiconductor memory devices, using an encryption tool, the portability-type semiconductor memory device is enciphered, or the data which is written and preserved to the portability-type semiconductor memory device is enciphered.

However, when the code is analyzed by the third party, the data saved in the portability-type semiconductor memory device may flow out. As a measure, it could be considered that a code is changed. But, when there was no portability-type semiconductor memory device to a user, there were problems that it could not be changed and deleted a code not to be flowed out the data by a third party.

Thus, this embodiment provides a portability type semiconductor memory device which performs data protection to access from external inaccurate host equipment.

A schematic explanation of this embodiment is as follows.

Hereinafter, the embodiment for implementing the invention is described. On the occasion of this explanation, a common reference mark is given to the portion which is common in a complete diagram. As an example of the portability-type semiconductor memory device, each following embodiment explains using a memory card. The portability-type semiconductor memory device is not limited to a memory card. For example, there are specifically SD card and external HDD and, USB memory.

### THE FIRST EMBODIMENT

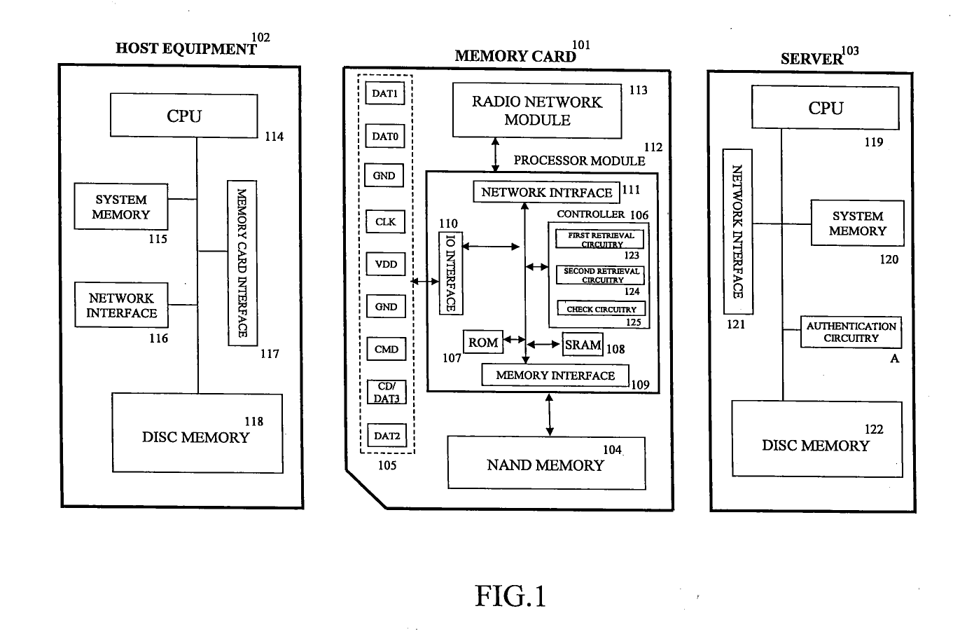

The memory card 101 of a first embodiment is explained with reference from FIG. 1 to FIG. 6. FIG. 1 is a system structure figure about a memory card 101 and a host equipment 102 connected with the memory card 101 and a server 103 connected the memory card 101 by a network.

First, the composition of the memory card 101 is explained. The memory card 101 is provided with a processor module 112, a NAND memory 104, a terminal for an interface 105, and a radio network module 113.

The processor module 112 manages operation of the memory card 101 whole. The processor module 112 is provided with a controller 106, SRAM 108, ROM 107, an IO interface 110, a network interface 111, and a memory interface 109.

The controller 106 makes the main control of the memory card 101, and orders the writing of data, read-out, and elimination to the NAND memory 104. The controller 106 manages the data storage state by the NAND memory 104.

The management of a memory state includes that the page (or block) of physical address manages physical address connected it and the page (or block) of physical address is states erased (state of nothing being written in or holding invalid data).

Each function which the controller 106 realizes in this embodiment is realizable as either hardware and software, and both combination. It is dependent on the design constraint imposed on the concrete embodiment or the whole system whether a function is realized as hardware or software. Although the skilled person can realize these functions by various methods for every concrete embodiment, opting for such realization is included under the category of the present invention.

The controller 106 is provided with a first retrieval circuitry 123, a second retrieval circuitry 124, and a check circuitry 125.

The first retrieval circuitry 123 searches for the least one access point within communicating range of the communications circuitry, based on the stored information.

The second retrieval circuitry 124 searches for the server through the access point, based on the stored information.

The check circuitry 125 checks authentication result received via the communications circuitry from the server.

The SRAM 108 is used as a work buffer memory. The control program and various kinds of data are memorized temporarily. ROM 107 is stored the control program.

The IO interface 110 is connected with nine terminals for an interface of the memory card 101, and interfaces the memory card 101 and the host equipment 102. The IO interface 110 is equivalent to an interface circuitry of the portability-type semiconductor memory device.

The network interface 111 communicates with the radio network module 113.

The memory interface 109 communicates with the NAND memory 104.

The NAND memory 104 is classified into a flash memory according to a semiconductor memory device. A flash memory is a memory suitable for memory of a file, and has a unit of erase blocks and performs elimination in this erase-blocks unit. The NAND memory 104 is accessible per page. This page unit comprises a 512 byte+16 byte, and is the minimum access unit of the NAND memory 104. The 16 bytes of 512 byte+16 byte are area currently prepared for the error correction, and actually storable data is 512 Byte. The NAND memory 104 is equivalent to a non-transitory computer readable memory of the portability-type semiconductor memory device.

The terminal for an interface 105 manages connection by attachment and detachment with an external device.

The radio network module 113 may be a module for realizing the wireless network represented by IEEE802.11 to which standardization is advanced in Institute of Electrical and Electronic Engineer (it is called IEEE for short below). For example, when it connects with LAN, it adds the header information of IEEE802.11 conformity to the packet of TCP/IP within this module and also performs digital modulation to transmit data on radio and transmits the data to an access point and performs network connection. It becomes possible to connect with a network via an access point by using this module. The wireless network module 113 is equivalent to the communications circuitry of the portability-type semiconductor memory device.

After, the host equipment 102 is explained. The host equipment 102 is provided with a memory card interface 117, CPU 114, a system memory 115, a network interface 116, and a disc memory 118. For example, the host equipment 102 is refreshable mobile computing devices about digital equipment, a digital camcorder, a digital still camera, a mobile phone, music, and images including a personal computer.

The memory card interface 117 can equip with the memory card 101.

The CPU 114 is a control center of the host equipment 102, and controls the host equipment 102 whole. The system memory 115 comprises RAM. The network interface 116 communicates with an external device. The disc memory 118 stores the driver for access of the memory card 101 to access the memory card 101. Concretely, the disc memory 118 is a hard disk.

Then, the server 103 is explained. The server 103 is provided with CPU 119 which makes the control center of the server 103, a system memory 120 which comprises a hard disk drive unit, a disc memory 122 which is a hard disk, a network interface 121, an authentication circuitry A.

The network interface 121 is equivalent to the radio network module 113 carried in the memory card 101, and is for exchanging in the memory card 101 via wireless LAN.

The authentication circuitry A judges and attests whether the certification information stored in the memory card 101 a priori and the certification information stored in the server 103 a priori are in coincidence.

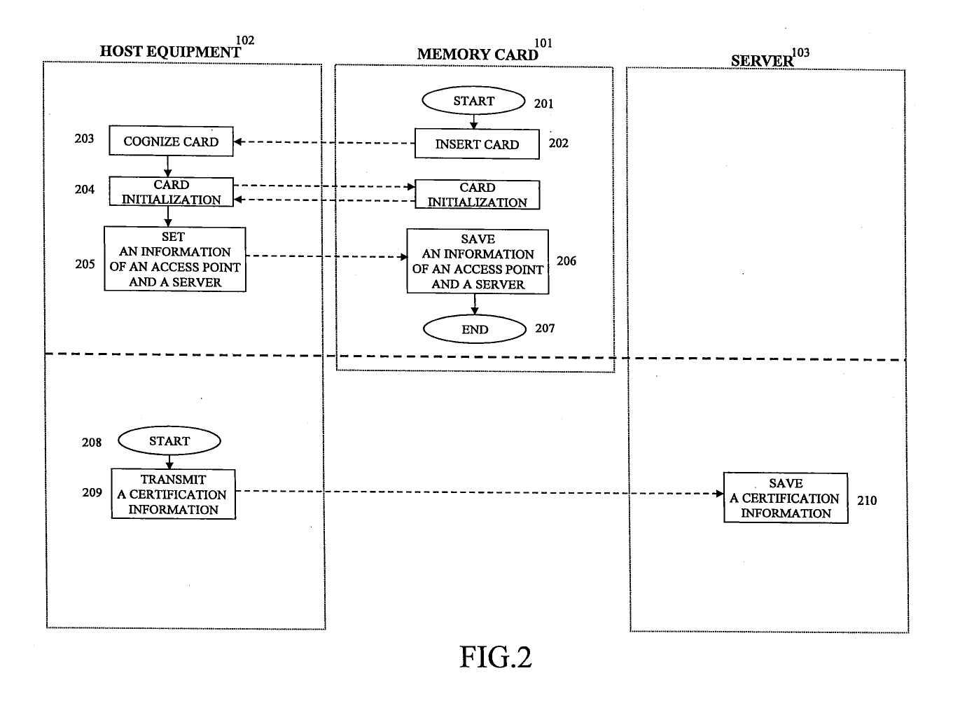

After, the setting method before using the memory card 101 mentioned above is explained. FIG. 2 is a flow chart which shows the flow of the setting method before using the memory card 101.

Before using the memory card 101, the user registers the certification information set up a priori into each of the memory card 101 and the server 103 as initial setting. In order to exchange the certification information with the server 103, the memory card 101 uses the wireless network module 113 of the memory card 101, and it connects with the server 103 via a network.

Then, the user who uses the memory card 101 considers of the operating environment of the memory card 101 and registers into the memory card 101 the information of the access point in which the server 103 is able to be connected.

The server 103 connected with the memory card 101 registered a priori via the connectable access point is chosen freely, and the information of this server 103 is registered into the memory card 101.

The use range can be limited so that the memory card 101 can be used only to be within the limits of the connectable access point which the user chose and was registered a priori. And also server 103 can connects the memory card 101 registered a prior by the user which is within the limits of a connectable access point registered a priori.

Hereinafter, the flow of the concrete setting method about the above is explained.

When the memory card 101 is inserted in the memory card interface 117 which the host equipment 102 has, in the state where the power supply of the host equipment 102 is switched on, or when the power supply of the host equipment 102 is switched on, in the state where the memory card 101 is inserted, the memory card 101 will be in the state where the power supply was switched on (Act 201).

At this time, the host equipment 102 recognize the memory card 101 (Act 203), and the memory card 101 is initialized in order to change the memory card 101 into an accessible state (Act 204). The initialization is that the space of the NAND memory 104 of the memory card 101 is the processing which it changes into an accessible state from the host equipment 102 and is the processing which it changes into the state where a reading command is receivable from the host equipment 102.

When the initialization processing of the memory card 101 is completed, the host equipment 102 will transmit the information of an access point to connect the server 103 and the information of the server 103 which the user selected to connect a priori, for the memory card 101 (Act 205).

And the memory card 101 stores in the NAND memory 104 the information of the server 103 and the information on an access point which were transmitted from the host equipment 102 (Act 206).

The host equipment 102 transmits certification information to the server 103 (Act 209). The server 103 saves certification information at the disc memory 122.

The certification information is information registered into the memory card 101 and the server 103 by the user a priori, and it uses for the security to the connection from the inaccurate outside whose intention the user does not have. Concretely, for example, there is a peculiar ID and a serial number which the memory card 101 has or a code which the user decided.

The certification information is transmitted to the host equipment 103 via the IO interface 110 in the case of initialization of the memory card 101.

The processing the host equipment 102 registers the information into the memory card 101 and the server 103 should just carry out once, and afterwards the 2nd time the information which is saved at the memory card 101 and the server 103 shall be used.

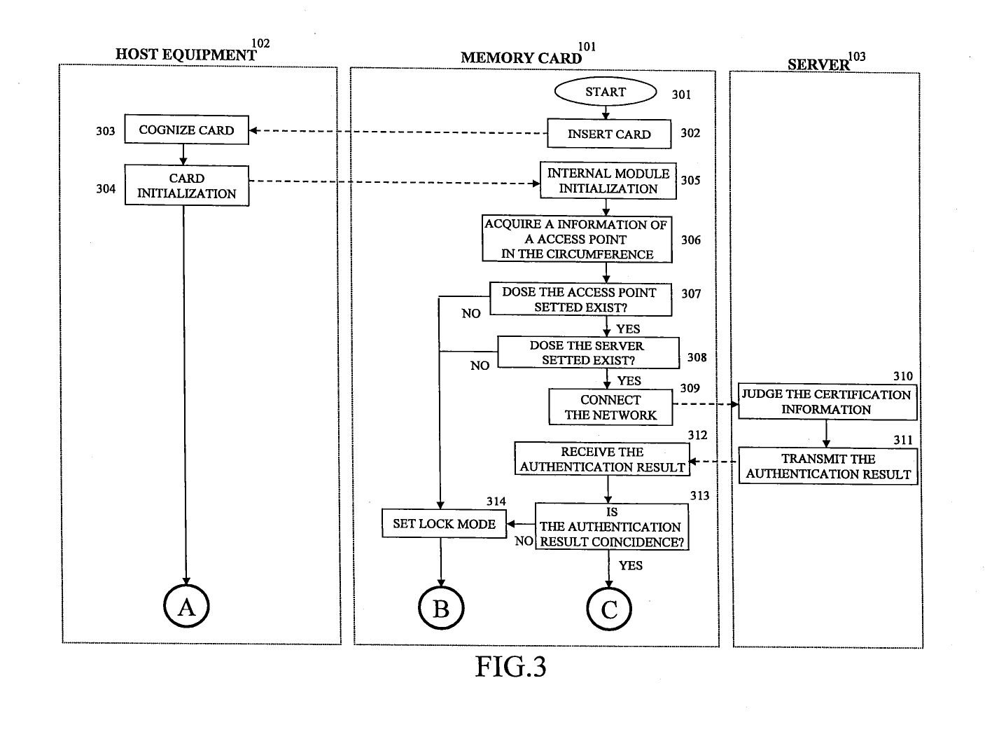

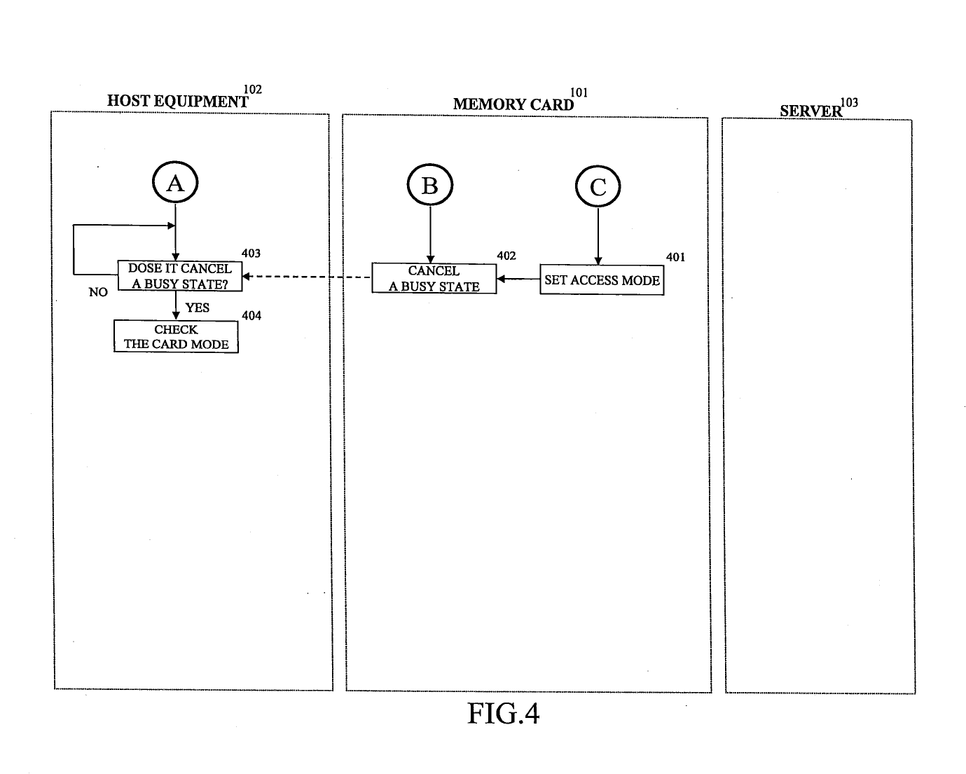

After, a system action including the memory card 101, the host equipment 102, and the server 103 which were mentioned above is explained. FIG. 3 and FIG. 4 are flow charts which show the flow of a system action including the memory card 101, the host equipment 102, and the server 103.

When the memory card 101 is inserted in the memory card interface 117 which the host equipment 102 has, in the state where the power supply of the host equipment 102 is switched on, or when the power supply of the host equipment 102 is switched on, in the state where the memory card 101 is inserted, the memory card 101 will be in the state where the power supply was switched on (Act 302).

At this time, the host equipment 102 recognize the memory card 101 (Act 303), and the memory card 101 is initialized in order to change the memory card 101 into an accessible state (Act 304).

When a power supply is switched on, the memory card 101 will initialize each internal module (Act 305). Then, when internal initialization processing is completed, the memory card 101 will transmit a busy signal to the host equipment 102.

The host equipment 102 waits for until a busy state is canceled (NO of Act 403). When the busy state of the memory card 101 releases, the host device 102 will recognize that the processing in the memory card 101 completed (Act 404).

A busy state is that the memory card 101 will be in the state where the command from the host equipment 102 is not receivable. When a busy state is canceled, the memory card 101 will be in the state where the command from the host equipment 102 is receivable. This information is sent to the host device 102 from the memory card 101 as a busy signal (or packet information sent to the host equipment 102 from the memory card 101).

The wireless network module 113 acquires the information of the access point which can communicate the circumference, with scanning (Act 306).

It is searched whether the access point initial set by the user exists in grasp, from the information of the access point acquired at Act 206 of FIG. 2 (Act 307).

If the access point by which initial setting is carried out does not exist (NO of Act 307), the memory card 101 is set as a lock mode (Act 314). The lock mode is that the memory card 101 becomes the mode which disregards all demands to access from the host equipment 102.

If the access point exists (YES of Act 307), the memory card 101 searches the server 103 in an access point based on the information of the server 103 which the user registered a priori (Act 308).

If the server 103 does not exist in the access point (NO of Act 308), the memory card 101 is set as the lock mode (Act 314).

If the server 103 exists in the access point (YES of Act 308), the memory card 101 connects with the server 103 in the access point.

The memory card 101 transmits the certification information stored in the NAND memory 104 a priori via the IO interface 110 to the server 103 in an access point which the user registered a priori.

The server 103 receives the information stored beforehand in the NAND memory 104 of the memory card 101.

And it judges and attests that the information of the memory card 101 saved at Act 210 at the time of initial registration of FIG. 2 is coincidence or whether it is inharmonious (Act 310), and transmits the authentication result to the memory card 101 (Act 311).

The memory card 101 receives the authentication result from the server 103 via the radio network module 113 (Act 312), and checks the authentication result (Act 313).

If the authentication result is inharmonious (NO of Act 313), the internal mode is set as the lock mode (Act 314).

If the authentication result is coincidence (YES of Act 313), the internal mode is set as the access mode which permits the data access from the outside (Act 401). Access mode is that the NAND memory 104 becomes the mode which permits all demands to access from the host equipment 102.

When it is decided that the internal mode will be the lock mode or the access mode, the memory card 101 will cancel the busy state to the host equipment 102 (Act 402), and will complete initialization processing (YES of Act 403).

And the host equipment 102 checks whether the memory card 101 is the access mode or the lock mode (Act 404).

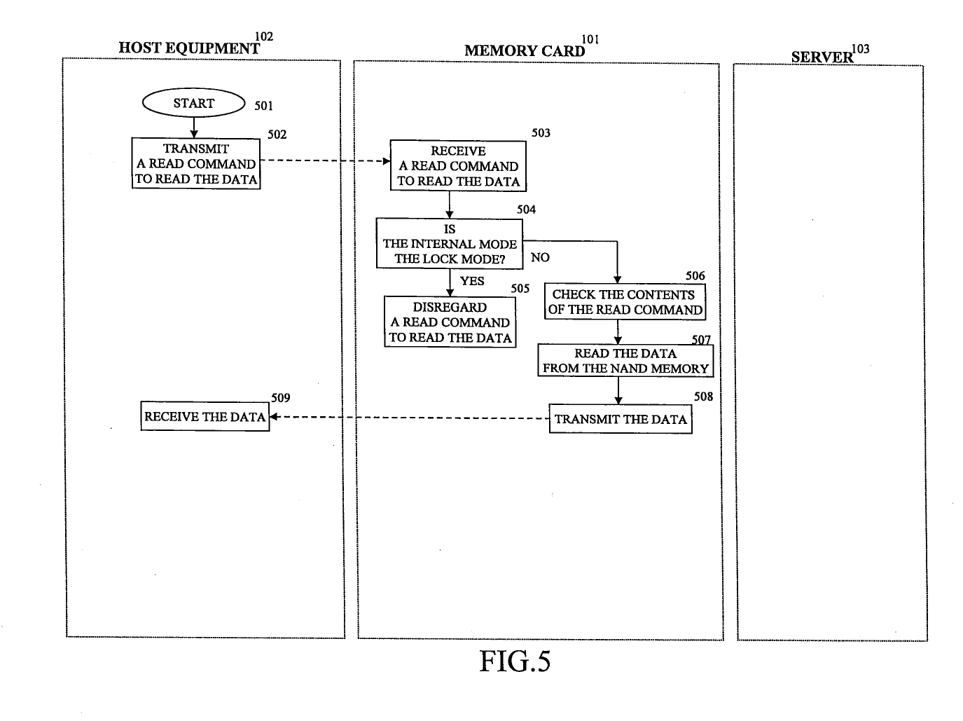

After, operation in case the host equipment 102 reads the data of the memory card 101 is explained. FIG. 5 is a flow chart which shows the flow of operation in case the host equipment 102 reads the data of the memory card 101.

The host equipment 102 publishes the read command in order to read the data of the NAND memory 104 of the memory card 101 (Act 502).

The memory card 101 receives the read command via the IO interface 110 (Act 503). And the present internal mode checks which of a lock mode or access mode it is (Act 504).

When the internal mode is the lock mode (YES of Act 504), the memory card 101 does not reply the response to the read command from the host equipment 102 to host equipment 102, and disregards the read command (Act 505).

When the internal mode is the access mode (NO of Act 504), the contents of the read command from the host equipment 102 are checked (Act 506).

After, the memory card 101 reads data from the NAND memory 104 (Act 507), and transmits read data to the host equipment 102 (Act 508).

And the host equipment 102 receives the read data from the memory card 101 via the memory card interface 117 (Act 509).

When the internal mode of the memory card 101 is the access mode (NO of Act 504), the host equipment 102 can acquire the data from the NAND memory 104, but when internal mode is the lock mode (YES of Act 504), the data of the NAND memory 104 cannot be acquired.

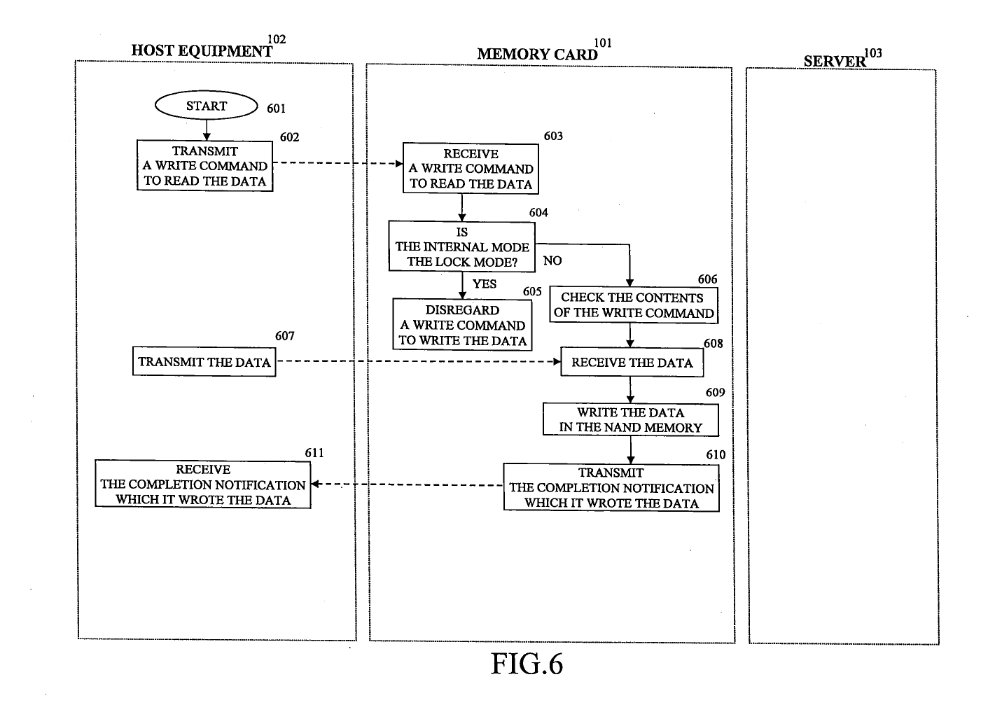

After, operation in case the host equipment 102 writes in the data of the memory card 101 is explained. FIG. 6 is a flow chart which shows the flow of operation in case the host equipment 102 writes in the data of the memory card 101.

The host equipment 102 publishes the write command in order to write data in the NAND memory 104 of the memory card 101 (Act 602).

The memory card 101 receives the write command via the IO interface 110 (Act 603). And the present internal mode checks which of the lock mode or the access mode it is (Act 604).

When the internal mode is the lock mode (YES of Act 604), the memory card 101 dose not reply the response to the write command from the host equipment 102 to the host equipment 102, and the write command is disregarded (Act 605).

When the internal mode is the access mode (NO of Act 604), the contents of the write command from the host equipment 102 are checked (Act 606). Then, the host equipment 102 transmits the data to the memory card 101 (Act 607).

After, the memory card 101 receives the data from the host equipment 102 (Act 608), writes the received data in the NAND memory 105 (Act 609), and transmits to the host equipment 102 completion notification which it wrote the data (Act 610). The host equipment 102 receives the completion notification which it wrote the data from the memory card 101 (Act 611).

When the internal mode of the memory card 101 is the access mode (NO of Act 604), the host equipment 102 can write the data in the NAND memory 104. But when the internal mode is the lock mode (YES of Act 604), the data cannot be written in the NAND memory 104.

According to the first embodiment of the above, the information of the server 103 and the access point which a user connects a priori is chosen. Based on this information, the memory card 101 attests the server 103.

Thereby, if the memory card 101 is not carried in within the limits of the connectable access point even if a user should lose the memory card 101, the memory card 101 does not become access mode and the use range of the memory card can be limited.

Thereby, the data of the memory card 101 is not spilt out for the third party besides the range of the access point.

In addition, even if a plurality of servers were within the limits of the access point, the memory card 103 can choose the server 103 using the information of the server 103 which the user registered into the memory card 101 a priori.

Also, in the first embodiment of the above, a user registers into the memory card 101 and the server 103 the certification information set up a priori, respectively.

And the certification information registered into the memory card 101 and the certification information registered into the server 103 are judged and attested whether are coincidence or inharmonious.

The memory card 101 checks the authentication result, and if the certification information is coincidence, it will become the access mode, and if the certification information is inharmonious, it will become the lock mode.

By this, even if a user should lose the memory card 101, if the certification information registered into the server 103 is changed or eliminated, it will not be attested. And, even if the memory card 101 is carried in within the limits of a connectable access point, the data of the memory card 101 will not be spilt out for the third party of the range of an access point.

Therefore, in the security of the codes such as the conventional password, if the user should have lost the memory card and the code was solved by the third party, the data was spilt out. But, by the first embodiment of the above, even if a user loses the memory card 101, the data is not spilt out for the third party, and it becomes strengthening of security.

### THE SECOND EMBODIMENT

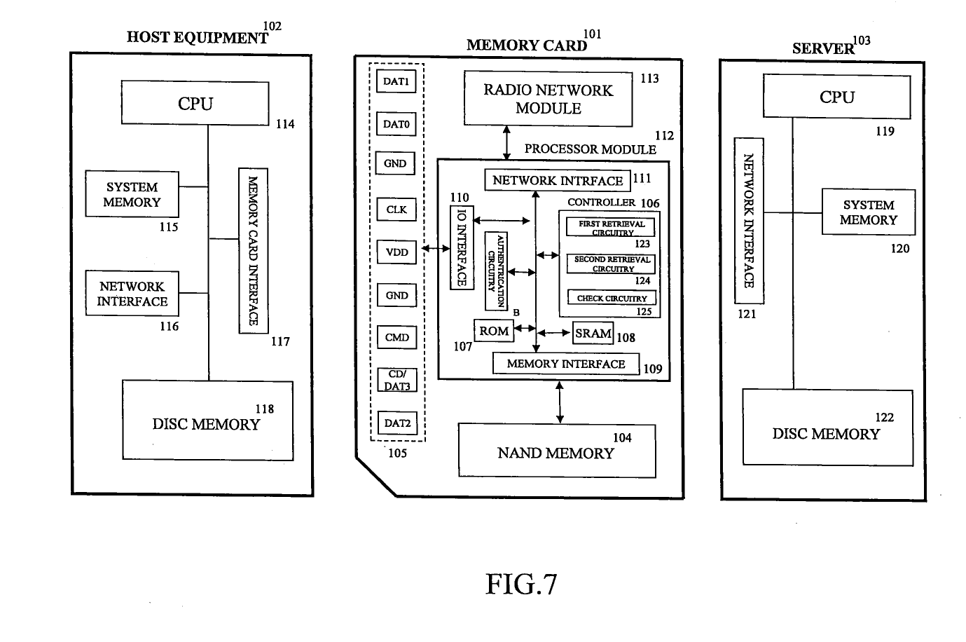

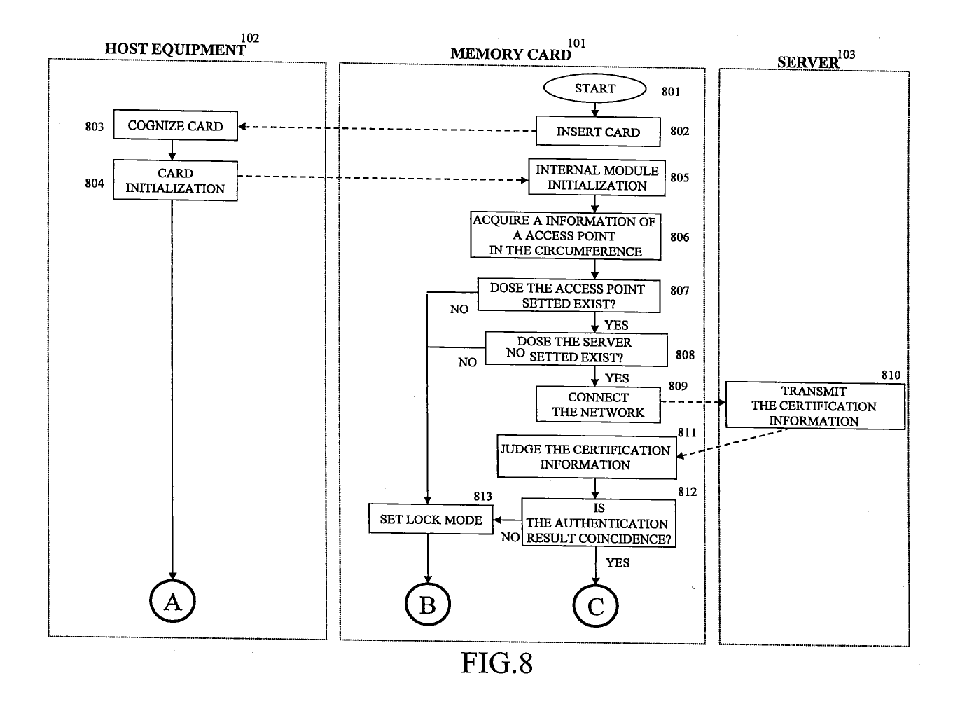

After, the memory card 101 concerning the second embodiment is explained using FIG. 7 and FIG. 8.

The second embodiment is related with an example which changes the flow of the system action including the memory card 101, the host equipment 102, and the server 103 by performing that the memory card 101 judges and attests the certification information which the user registered a priori with.

In this explanation, detailed explanation of the portion which overlaps with the first embodiment of the above is omitted.

In the first embodiment the server 103 is provided the authentication circuitry A which judged and attested possesses whether the certification information stored in the memory card 101 a priori and the inharmonious certification information stored in the server 103 a priori are in coincidence. While, as shown in FIG. 7, in the second embodiment the authentication circuitry A of the server 103 is lost, and the memory card 101 is provided the authentication circuitry B with the same function as the authentication circuitry A.

Act 809 of FIG. 8 which is the flow chart shows the flow of the system action of the second embodiment is the same even as the place (Act 309) which carries out network connection to the access point of FIG. 3 which is the flow chart shows the flow of the system action of the first embodiment.

The server 103 transmits the certification information transmitted from the host equipment 102 at the time of initial setting to the memory card 101 (Act 810).

The memory card 101 acquires the certification information registered at the time of initial setting from the server 103.

And the authentication circuitry B judges and attests whether the certification information registered into the memory card 101 a priori and the certification information received from the server 103 are coincidence or inharmonious (Act 811).

And the memory card 101 checks the authentication result (Act 812). The flow of after operation is the same as the first embodiment of the above.

Even if the user loses the memory card 101 like the first embodiment also in the second embodiment of the above, spilling out data for a third party is lost, and it becomes strengthening of security.

As mentioned above, according to the memory card concerning each embodiment mentioned above, the memory card which performs data protection for access from external inaccurate host equipment can be provided.

Although each above-mentioned embodiment can be limited to the access point and server 103 specified by a user by registering the information of the server 103 and the access point which the user connects to the memory card 101 a priori, the danger that limiting this access point and this server will also reveal information to the third party is avoidable enough.

In addition each above-mentioned embodiment is not the only embodiment, and a variety of transmutation is possible for it.

Also the mode chosen after the memory card 101 checks the certification information is in two types, but it can be consider a variety of patterns about the setup in the mode.

For example, in each above-mentioned embodiment, it is supposed that it forbids read and write of all the data of the memory card 101 by the lock mode.

However, not only above-mentioned embodiment, it may be carried out such as reading some data of the memory card 101 and performing the writing to data.

Namely, as the result of the memory card 101 checking the authentication result, when it is inharmonious, the memory card 101 become the lock mode which disregards the read command and write command of data, but, instead of what was restricted to this, only the specific command may not come to operate, or only a specific command may stop operating, or all the commands may stop operating.

Also, although the information of the one memory card 101 is saved at the server 103, the information of two or more memory cards 101 may be saved.

Similarly, although only the information of one set of the server 103 is set to the memory card 101, the information of two or more sets of the servers 103 may be saved at the memory card 101.

And the means by which the memory card 101 notifies termination of various operations to the host equipment 102 is not restricted to a busy signal, but may use other signals. For example, it can also notify by sending a packet to the host equipment 102 from the memory card 101 to the timing which the busy completed.

Also each above-mentioned embodiment is explained as a server supposing the PC server.

However, the server 103 is not what was restricted to the PC server, and just performs an exchange of data via a network. For example, it may be a memory card which carries a wireless network function. And the flow chart figure explained by each above-mentioned embodiment can replace turn as much as possible, and can perform a plurality of processing simultaneously.

Also, if it is the composition that not only the composition of FIG. 1 but the function explained by each above-mentioned embodiment is realizable, hardware and software will not be restricted and the composition which the memory card 101, the host equipment 102, and the server 103 can take will not be limited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portability-type semiconductor memory device comprising:
communications circuitry configured to transmit data to, and receive data from, a server via a network;
interface circuitry configured to transmit data to, and receive data from, a host device;
a non-transitory computer readable memory configured to store information of at least one access point and the server received from the host device via the interface circuitry;
first retrieval circuitry configured to search for the least one access point within communicating range of the communications circuitry, based on the stored information; and
second retrieval circuitry configured to search for the server through the access point, based on the stored information; wherein
if the at least one access point is not within communicating range, the portability-type semiconductor memory device is configured to disregard commands from the host device, and
if the at least one access point is within communicating range, as determined by the first retrieval circuitry, the second retrieval circuitry is further configured to determine whether the server is accessible through the access point, based on the stored information.

2. The portability-type semiconductor memory device according to claim 1, wherein
if the at least one server is not within the access point, as determined by the second retrieval circuitry, the portability-type semiconductor memory device is configured to disregard commands from the host device, and
if the at least one server is within the access point, as determined by the second retrieval circuitry, the portability-type semiconductor memory device connects with the server in the access point.

3. The portability-type semiconductor memory device according to claim 1, the portability-type semiconductor memory device further comprising:
check circuitry configured to check authentication result received via the communications circuitry from the server, wherein
the communications circuitry transmits certification information stored in the non-transitory computer readable memory to the server.

4. The portability-type semiconductor memory device according to claim 1, the portability type semiconductor memory device further comprising:
authentication circuitry configured to judge and attest whether it is coincidence with the certification information received via the communications circuitry from the server and the certification information which the non-transitory computer readable memory stores priori; and
check circuitry configured to check authentication result by the authentication circuitry, wherein
the communications circuitry receives the certification information registered from the server.

5. The portability-type semiconductor memory device according to claim 3, wherein
if the authentication result is inharmonious, as determined by the check circuitry, the portability-type semiconductor memory device is configured to disregard commands from the host device, and
if the authentication result is coincidence, as determined by the check circuitry, the portability-type semiconductor memory device permits demands to a command from the host equipment.

6. A method of operating a portability-type semiconductor memory device, the method comprising:
executing a processing for transmitting data to, and receive data from, a server via a network;
executing a processing for transmitting data to, and receive data from, a host device;
executing a processing for storing information of at least one access point and the server received from the host device via the interface circuitry;
executing a first processing for searching for the least one access point within communicating range of the communications circuitry, based on the stored information; and
executing a second processing for searching for the server through the access point, based on the stored information, wherein
if the at least one access point is not within communicating range, the portability-type semiconductor memory device executes a processing for disregarding commands from the host device; and
if the at least one access point is within communicating range, as determined by the first processing, the portability-type semiconductor memory device executes the second processing for determining whether the server is accessible through the access point, based on the stored information.

7. The method of claim 6, wherein the executing the processing includes:
if the at least one server is not within the access point, the portability-type semiconductor memory device executes a processing for disregarding commands from the host device; and
if the at least one server is within the access point, the portability-type semiconductor memory device executes a processing for connecting with the server in the access point.

8. The method of claim 6, further comprising:
executing a processing for checking authentication result received via the communications circuitry from the server, and
executing a processing for transmitting certification information stored in the non-transitory computer readable memory to server.

9. The method of claim 6, further comprising:
executing a processing for judging and attesting whether it is coincidence with the certification information received via the communications circuitry from the server and the certification information stored in non-transitory computer readable memory; and
executing a processing for checking the authentication result by the processing for judging and attesting, and
executing a processing for receiving the certification information registered from the server.

10. The method of claim 8, wherein the executing the processing includes:
if the authentication result is inharmonious, as determined by the processing for checking, the portability-type semiconductor memory device executes a processing for disregarding commands from the host device; and
if the authentication result is coincidence, as determined by the processing for checking, the portability-type semiconductor memory device executes a processing for permitting demands to a command from the host equipment.
